(19) United States
(12) Patent Application Publication
(10) Pub. No.: US 2010/0057439 A1
(43) Pub. Date: Mar. 4, 2010

(54) PORTABLE STORAGE MEDIUM STORING TRANSLATION SUPPORT PROGRAM, TRANSLATION SUPPORT SYSTEM AND TRANSLATION SUPPORT METHOD

(75) Inventors: Masao Ideuchi, Kawasaki (JP); Kaoru Shimamura, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/476,319

(22) Filed: Jun. 2, 2009

(30) Foreign Application Priority Data
Aug. 27, 2008 (JP) 2008-217560

(51) Int. Cl. G06F 17/28

(52) U.S. Cl. 704/7

(57) ABSTRACT

A portable storage medium storing a translation support program supporting translation of an original document being document data containing Japanese and a foreign language for expressing a word of one language in another language includes: correcting the correction target character contained in the original document in accordance with the correction detail information, and generating a corrected original document; replacing each character constituting the corrected original document with a character type symbol, and describing adjacent same character type symbols with one symbol; replacing each character type symbol constituting the character type symbol string with a language symbol, and describing adjacent same language symbols with one symbol; extracting language symbols from adjacent language symbols and obtaining, from the pair, a word pair of a Japanese word and a word in the foreign language; and registering the word pair.

### CROSS-REFERENCE TO RELATED APPLICATION

This application is based upon and claims the benefit of priority of the prior Japanese Patent Application No. 2008-217560, filed on Aug. 27, 2008, the entire contents of which are incorporated herein by reference.

### FIELD

The technique disclosed herein relates to a machine translation support technique.

### BACKGROUND

English-Japanese machine translation software translates English with Japanese using a translation dictionary that defines the Japanese translation of English words. When an original document (translation target) containing a word that is not defined in the translation dictionary is input, the word is processed as an unknown word. An unknown word is often displayed in the translation result as it is without being translated, contributing to incomplete translation results. In such a case, the manual registration of the word to the translation dictionary performed by a human facilitates the machine translation.

Meanwhile, the Japanese language has a characteristic that the language can contain a mixture of various types of characters such as English words. As Weblogs have become widely used, an increasing number of articles on up-to-date topics are posted on the Internet. Against such a backdrop, there have been more cases in which one performs an Internet search when he/she does not know the translation of an English word, to find a translation word in a translation dictionary on a Japanese Webpage and the like.

Documents related to the technique disclosed herein include Japanese Laid-open Patent Publication No. 2002-297589 and Japanese Laid-open Patent Publication No. 09-179866.

### SUMMARY

According to an aspect of the embodiment, in a portable storage medium storing a translation support program that makes a computer execute processes supporting translation of an original document being document data containing Japanese and a foreign language for expressing a word of one language in another language, the program includes:

an original document correction process correcting, on the basis of a correction related information storing a correction target character and correction detail information for the correction target character, the correction target character contained in the original document in accordance with the correction detail information, and generating a corrected original document;

a character type symbol string generation process replacing each character constituting the corrected original document with a character type symbol that is a symbol specifying a type of a character, and generating a character type symbol string in which one symbol is used for describing adjacent same character type symbols;

a language symbol string generation process replacing each character type symbol constituting the character type symbol string with a language symbol that is a symbol specifying a language, and generating a language symbol string in which one symbol is used for describing adjacent same language symbols;

a word pair obtaining process extracting, from adjacent language symbols in the language symbol string, language symbols that are different from each other, and obtaining, from the extracted pair, a word pair of a Japanese word corresponding to a combination pattern of the character type symbols related to a language symbol representing Japanese and a word in the foreign language corresponding to the Japanese word; and

a translation word candidate registration process registering, with respect to one word in the obtained word pair, another word in the obtained word pair as a translation word candidate of the one word in the obtained pair.

The object and advantages of the invention will be realized and attained by means of the elements and combinations particularly pointed out in the claims.
It is to be understood that both the foregoing general description and the following detailed description are exemplary and explanatory and are not restrictive of the invention, as claimed.

### BRIEF DESCRIPTION OF DRAWINGS

FIG. 1 is an outline diagram of a translation word candidate search system 1 in the first embodiment.

FIG. 2 is a configuration diagram of a word analysis unit 3 in the first embodiment.

FIG. 3 is an example of a correction code table 16 in the first embodiment.

FIG. 4 is a flow for an original document correction processing unit 11 in the first embodiment.

FIG. 5 is an example of a character type code table 17 in the first embodiment.

FIG. 6 is a flow for a character type description processing unit 12 in the first embodiment.

FIG. 7 is an example of a language definition table 18 in the first embodiment.

FIG. 8 is a flow for a language analysis unit 13 in the first embodiment.

FIG. 9 is an example of a word definition table 19 in the first embodiment.

FIG. 10 is a flow for a word processing unit 14 in the first embodiment.

FIG. 11 is an example of character type analysis using an example sentence performed by the word analysis unit 3 in the first embodiment.

FIG. 12 is an example of character type analysis based on the word definition table 19 performed by the word analysis unit 3 in the first embodiment.

FIG. 13 is a diagram for explaining an example of the extraction of a word in other example sentences in the first embodiment.

FIG. 14 is an example of a translation word candidate table stored in a translation word DB 5 in the first embodiment.

FIG. 15 is an example of the screen of a translation word candidate search system in the first embodiment.

FIG. 16 is a configuration example of a network in the first embodiment.

FIG. 17 is an outline of a system 51 that performs word analysis for the search result of a search system in the second embodiment.

FIG. 18 is a configuration diagram of a word analysis unit 3 in the second embodiment.

FIG. 19 is an example of character type analysis using an example sentence performed by the word analysis unit 3 in the second embodiment.

FIG. 20 is an example of character type analysis based on a word definition table 19 performed by the word analysis unit 3 in the second embodiment.

FIG. 21 is a configuration example of a network in the second embodiment.

### DESCRIPTION OF EMBODIMENTS

For example, when searching for a Japanese translation of “Lake Windermere”, a search is performed on the Internet with “Lake Windermere” as a keyword. When the search result is displayed, the search result page is gone through to pick up Japanese translation word candidates such as [symbol] [symbol] and [symbol] Further, a search for each Japanese translation word candidate is performed to select, from the candidates with a larger number of hits on the Internet, the one that seems to be credible, as the Japanese translation word.

In the operation process, first, from the search result for “Lake Windermere”, Japanese translation word candidate character strings such as [symbol] [symbol] and [symbol] need to be selected by going through the search result.

However, depending on the number of the search and the data amount of the Webpage for which the search is performed, the operation may require some time, and a human error may lead to the missing out of some Japanese translation word candidates.

Thus, in the operation for finding a Japanese translation word that is not registered in a translation dictionary, the Internet search has been used for several times, with searched pages being repeatedly gone through. Then, a further search has been performed to determine the most suitable word as the Japanese translation word. For example, such a search has been repeated, the number of the repetition corresponding to the number of the Japanese translation word candidates, to obtain results such as “12 hits for [symbol] “3 hits for [symbol] and “6 hits for [symbol] and the Japanese translation word with the larger number of hits is determined as the most suitable Japanese translation word. As a result, there have been disadvantages such as more time being required for the operation, and a human error leading to the possible missing out of some Japanese translation word candidates.

Therefore, in the embodiments described below, a translation support program and a translation support system with which a Japanese translation word candidates can be obtained with a single keyword search are provided.

### First Embodiment

Described with this embodiment is a case of performing a search, with regard to a keyword of which Japanese translation word is sought, in a database (DB) in which candidates for Japanese translation words are registered in advance.

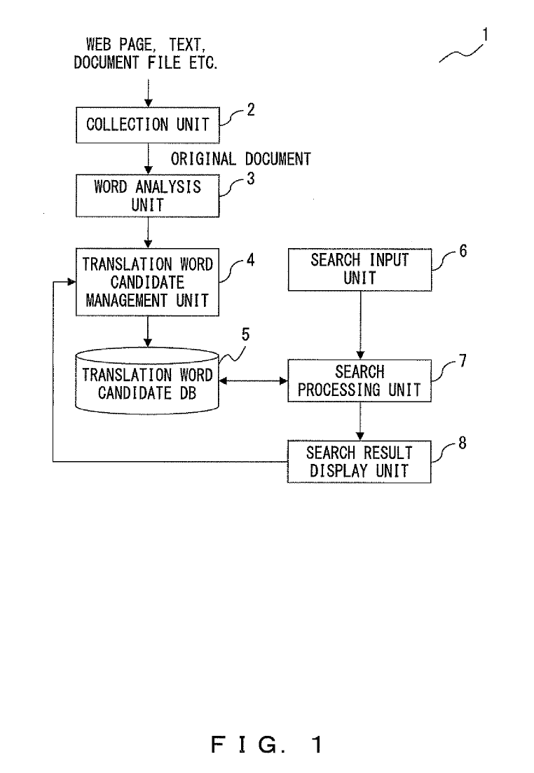

FIG. 1 is an outline diagram of a translation word candidate search system 1 in the present embodiment. The translation word candidate search system 1 has a collection unit 2, a word analysis unit 3, a translation word candidate management unit 4, a translation word candidate DB 5, a search input unit 6, a search processing unit 7, and a search result check unit 8.

The collection unit 2 collects Web pages in HTML (Hyper Text Markup Language) and the like, document files created by word processors and document files such as presentation materials, to extract an original document OD 1. The original document OD 1 is document data divided in units of sentences separated by punctuation mark such as “.” or in units of layout such as the index of HTML and word-processor documents, and so on. The collection unit 2 is a program such as, what is called, a Web crawler, collecting files such as accessible Web pages and the like.

The word analysis unit 3 extracts, from the original document OD 1, a word that has a possibility of being the translation word. The word analysis unit 3 generates a corrected original document OD 2 from which elements that are not the constituent elements of a word, such as parentheses, have been eliminated. Next, the word analysis unit 3 replaces the respective words that constitute the corrected original document OD 2 with character type symbols (character type format) that indicate “English alphabet” “Chinese character” “hiragana” “katakana”, and so on, to describe the corrected original document OD 2 with a character string composed of the character type symbols. Next, the word analysis unit 3 replaces the Japanese parts, English parts, etc. of the corrected document OD 2 with language codes (language format) that indicate the languages. After that, the word analysis unit 3 extracts words from a pair of different language codes adjacent to each other, in the corrected original document OD 2 described in the language format.

The translation word candidate management unit 4 stores the translation words and accompanying information of the translation words and the like extracted by the word analysis unit 3 in a storage system such as the translation word candidate DB 5. The translation word candidate management unit 4 registers and updates, in a storage system such as a DB, the number of extracted translation word candidates, the number of adopted translation words, a translation example of a word, the document being the source of the extraction, etc., as the accompanying information of a translation word candidate word.

The search input unit 6 inputs a keyword (a word of which a Japanese translation word is sought), and has, at least, input items such as a search button for starting the search process in the translation word candidate DB 5, a language button that can specify the language (such as Japanese, English) of the keyword and translation word, and so on. If the system involves only two languages such as Japanese/English, an automatic determination can be performed, in which the language of the keyword is determined by a process similar to that performed by the word analysis unit 3, and the other language is determined as the language for the translation word. In this case, the language button is not required.

The search processing unit is a program such as, so called, a full-text search engine, with which a search in the translation word candidate DB 5 can be performed on the basis of the keyword input by the search input unit 6 and the language of the keyword.

The search result display unit 8 displays a list of searched words and accompanying information of the words. The search result display unit 8 has an operation button that can specify the display order, such as a descending or ascending order with regard to the number of hits, a descending or ascending order with regard to the probability, and so on.

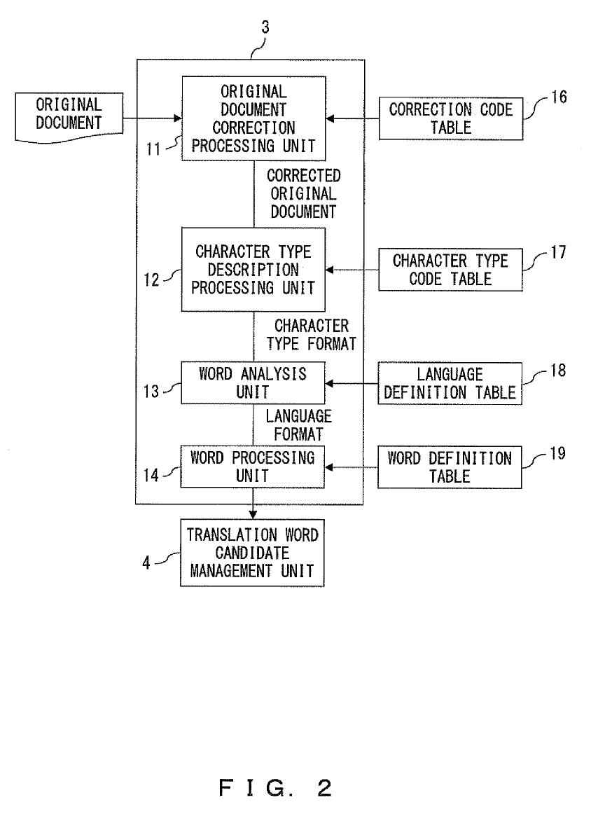

FIG. 2 illustrates the configuration of the word analysis unit 3 in the present embodiment. The word analysis unit 3 is capable of automatically extracting translation word candidates from the original document OD land storing them in the translation word candidate DB 5. The word analysis unit 3 has an original document correction processing unit 11, a character type description processing unit 12, a language analysis unit 13, and a word processing unit 14.

The original document correction unit 11 generates, from the original document OD 1, a corrected original document OD 2 from which elements, such as parentheses, that are unnecessary as the constituent elements of the words have been eliminated, on the basis of a correction code table 16.

The character type description processing unit 12 replaces the words constituting the corrected original document OD 2 with character type symbols that indicate “English alphabet” “Chinese character” “hiragana” “katakana” and so on, to describe the corrected original document OD 2 in a character string composed of the character type symbols (character type format), on the basis of a character type code table 17.

The word analysis unit 13 replaces the Japanese parts and the English parts respectively with language codes (language format) that indicate the languages, on the basis of a language definition table 18.

The word processing unit 14 extracts a word as a translation word candidate from a pair of different language codes adjacent to each other, in the corrected original document OD 2 described in the language format, on the basis of a word definition table 19. The word extracted as a translation word candidate is registered in the translation word candidate DB 5 by the translation word candidate management unit 4.

Next, a service in which a search is performed in the translation word candidate DB 5 with registered translation word candidates to improve the operation efficiency of translation done by a human is explained. First, the administrator of the service specifies a storage location of Web pages or document files that are to be collected. For example, the whole of an open Web page in an office LAN or a document depository shared on a network can be specified as the storage place. Then, the collection unit 2 extracts the original document OD 1 from the collected Web pages and document files.

The word analysis unit 3 performs the process illustrated in FIG. 2 for the original document OD 1 extracted from the collected Web pages and document files. Details of the process performed by the word analysis unit 3 in the present embodiment are described below.

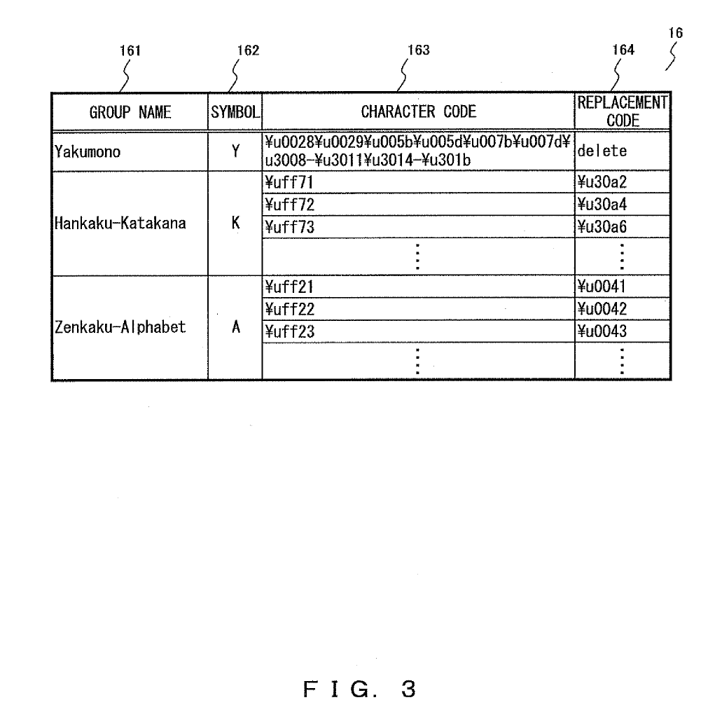

FIG. 3 illustrates an example of the correction code table 16 in the present embodiment. The correction code 16 describes the character codes of the characters to be corrected in the characters included in the original document OD 1. The correction code 16 is composed of items “group name” 161, “symbol” 162, “character code” 163, “replacement code” 164.

The group name of a character code to be corrected is stored in the “group name” 161. The character code to be corrected, included in the group, is stored in the “character code” 163.

A replacement code corresponding to the character code included in the group is stored in the “replacement code” 164. In accordance with the definition of an effective character code as the replacement code, the original document correction processing unit 11 replaces a character included in the “character code” 163 with a replacement code corresponding to the character.

The character codes “ [symbol] u0028 [symbol] u0029 [symbol] u005b [symbol] u005d [symbol] u007b [symbol] u007d [symbol] u3008- [symbol] u 3011 [symbol] u3014- [symbol] T 301b” included in the group name “Yakumono” indicate the unicodes of ( ) [ ] { } [symbol] ┌ ┘ [symbol] [symbol] . Accordingly, when the original document OD 1 contains these character codes, “delete” of them is performed.

The character codes “ [symbol] uff71 [symbol] uff72 [symbol] uff73 . . . ” included in the group name “Hankaku-Katakana” indicate one-byte katakana. The character codes “ [symbol] u30a2 [symbol] u30a4 [symbol] u30a6 . . . ” defined as the replacement codes indicate two-byte katakana. Since a large number of character codes are included, the examples of three characters are illustrated. Accordingly, when the original document OD 1 contains one-byte katakana characters, they are converted into two-byte katakana.

The character codes “ [symbol] uff21 [symbol] uff22 [symbol] uff23 . . . ” included in the group name “Zenkaku-Alphabet” indicate two-byte alphabets. The character codes “ [symbol] u0041 [symbol] u0042 [symbol] u0043 . . . ” defined as the replacement codes indicate one-byte alphabets. Since a large number of character codes are included, the examples of three characters are illustrated. Accordingly, when the original document OD 1 contains two-byte alphabet characters, they are converted into one-byte alphabets.

Meanwhile, new registration, edition and deletion can be performed for the correction code table 16. Since any character codes can be defined in the correction code table 16, it is beneficial to define symbols for which the identification of nationality by the language analysis us difficult, and so on.

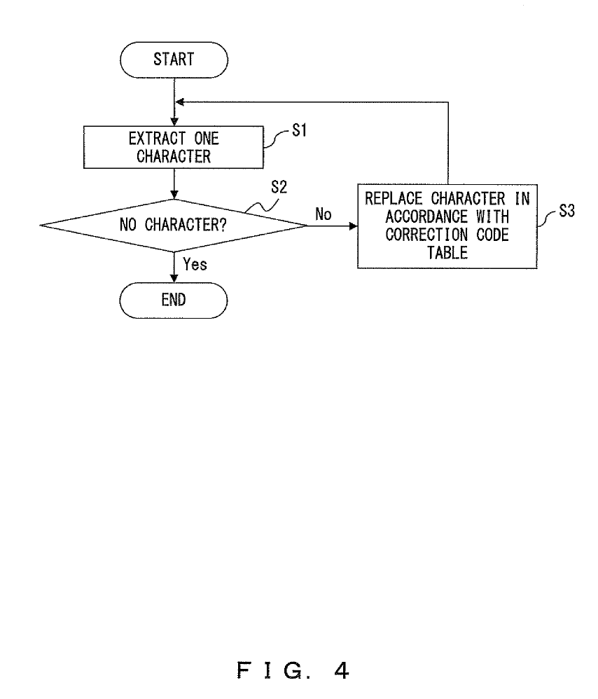

FIG. 4 illustrates the flow for the original document correction processing unit 11 in the present embodiment. The original document correction processing unit 11 extracts one character from the original document OD 1 (S1). When there is a character to extract (“No” in S2), the character is replaced in accordance with the correction code table 16 (S3). Specifically, when the one character extracted from the original document OD 1 corresponds to a character code in the correction code table 16, the original document correction processing unit 11 performs a correction process in accordance with the replacement code corresponding to the character code. For example, when the one character extracted from the original document OD 1 is a character code included in the group name “Yakumono”, the replacement code corresponding to the character code is “delete”. In this case, the original document correction processing unit 11 deletes the extracted one character from the original document OD 1.

The original document correction processing unit 11 performs the correction process from the beginning to the end of the original document OD 1, character by character. When there is no character to be extracted from the original document OD 1 any more (“Yes” in S2), the process performed by the original document correction processing unit 11 is terminated. Thus, the characters in the original document OD 1 are corrected in accordance with the replacement codes, generating the corrected original document OD 2.

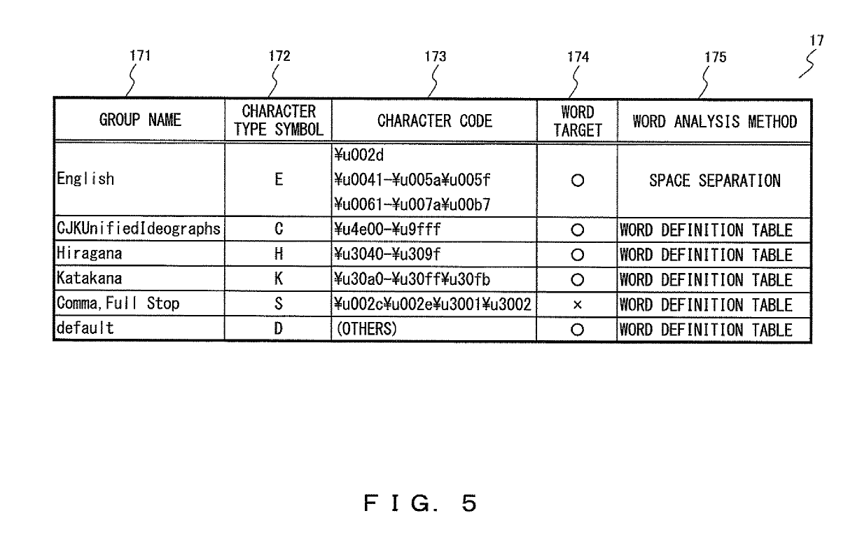

FIG. 5 illustrates an example of character type code table 17 in the present embodiment. The character type code table 17 replaces a character extracted from the corrected original document OD 2 with an abbreviation (character type symbol) corresponding to the character. In other words, it is used to convert the corrected original document OD 2 into the character type format. The character type code table 17 is composed of items “group name” 171, “character type symbol” 172, “character code” 173, “word object” 174, and “word analysis method” 175.

The group name to which a character code belongs to is stored in the “group name” 171. A symbol (character type code) indicating the abbreviation of the “group name” 171 is stored in the “character type symbol” 172.

The group name “English” contains “ [symbol] u002d” (=‘-’), “ [symbol] u0041” (=‘A’) to “ [symbol] u005a” (=‘Z’), “ [symbol] u005f” (=‘_’), “ [symbol] u0061” (=‘a’) to “ [symbol] u007a” (=‘z’), “ [symbol] u00b7” (=‘•’). The character codes contained in the group name “English” are described with the character type symbol “E”.

The group name “CJKUnifiedIdeographs” contains CJK Inified Ideographs (Chinese characters) represented by “ [symbol] u4e00” to “ [symbol] u9fff”. The character codes contained in the group name “CJKUnifiedIdeographs” are described with the character type symbol “C”.

The group name “Hiragana” contains hiragana represented by to “ [symbol] u3040” to “ [symbol] u309f”. The character codes contained in the group name “Hiragana” are described with the character type symbol “H”.

The group name “Katakana” contains katakana represented by “ [symbol] u30a0” to “ [symbol] u30ff” and “ [symbol] u30fb”. The character codes contained in the group name “Katakana” are described with the character type symbol “K”.

The group name “Comma, Full Stop” contains commas and punctuation marks represented by “ [symbol] u002c” (=‘,’), “ [symbol] u002e” (=‘.’), “ [symbol] u3001” (=‘,’), “ [symbol] u3002” (=‘∘’). The character codes contained in the group name “Comma, Full Stop” are described with the character type symbol “S”.

The group name “default” contains character codes represented by unicodes other than those in the groups mentioned above. The characters contained in the group name “default” are described with the character type symbol “D”.

The “word object” 174 stores information indicating whether or not the character is to be treated as a character type constituting a word. The “word target” 174 is used by the word processing unit 14. When the “word object” 174 of a group is indicated as “O”, the word processing unit 14 treats the characters contained in the group as the character types constituting a word. When the “word object” 174 of a group is indicated as “X”, the characters contained in the group are not adopted as the character types for a word. In FIG. 5, the character codes contained in the character type symbol “S” group are used as a basis for the determination of Japanese language in the language analysis unit 13, while they are excluded from the character type pattern determination in the word processing unit 14.

In the “word analysis method” 175, the method for word extraction is defined. “Space separation” means that, for the character type, words are to be extracted on the basis of the separation by spaces. Characters used for the space separation include a one-byte space “¥u0020”, a two-byte space “¥u3000”, a tab space “ [symbol] u0009”, and so on. Meanwhile, “word definition table” means that, for the character type, words are to be extracted using the word definition table 19.

Meanwhile, the character code table 17 lists the ones for which the replacement character codes are defined with character codes, i.e., the groups other than the group name “default”, first. New registration, edition and deletion can be performed for the character type code table 17.

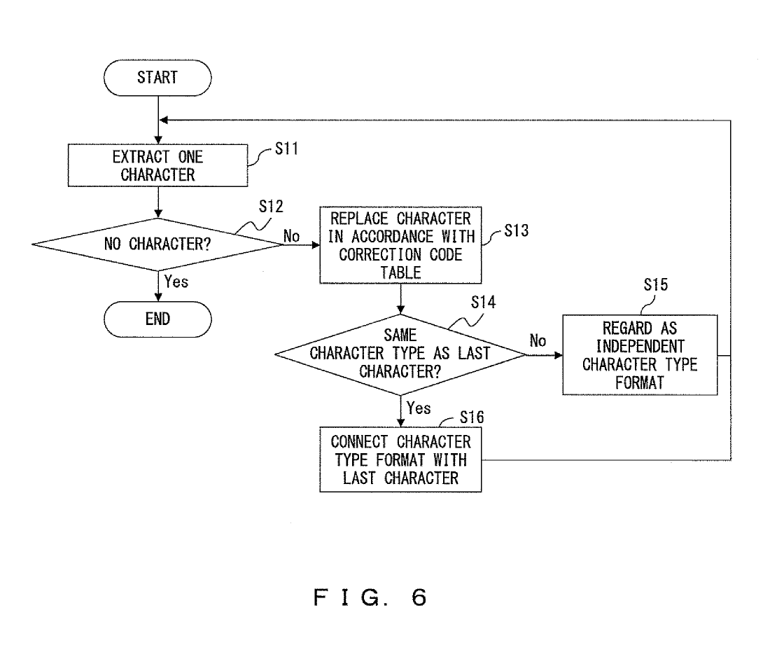

FIG. 6 illustrates the flow for the character type description processing unit 12 in the present embodiment. The character type description processing unit 12 extracts one character from the original document OD 2 (S11). When there is a character to extract (“No” in S12), the character type description processing unit 12 replaces the character in accordance with the character type code table 17 (S13). Specifically, when the one character extracted from the original document OD 2 corresponds to a character code in the character type code table 17, the character type description processing unit 12 replaces the character with a character type symbol corresponding to the character.

At this time, the character type description processing unit 12 determines whether the character type symbol involved in the current conversion corresponds to the same character type involved in the end conversion process (S14). When the character type symbol involved in the current conversion corresponds to the character type involved in the end conversion process (“Yes” in S14), the character type description processing unit 12 connects the character type symbol involved in the current conversion with the character type involved in the end conversion process. In other words, the character type symbol involved in the current process is omitted (S16).

When the character type symbol involved in the current conversion does not correspond to the character type involved in the end conversion process, (“No” in S14), the character type description processing unit 12 regards the character type symbol involved in the current conversion as a character type independent from the character type involved in the end conversion process.

The character type description processing unit 12 performs the correction process from the beginning to the end of the original document OD 2, character by character. When there is no character in the character type code 17 corresponding to one character obtained from the original document OD 2 in S13, the character type description processing unit 12 adopts the character type symbol “D” for which the character code is defined as “(others)”.

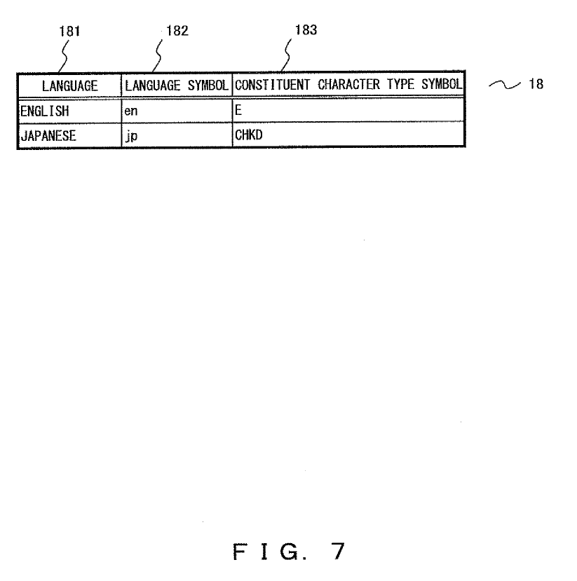

FIG. 7 illustrates an example of the language definition table 18 in the present embodiment. The language definition table 18 is used to determine the language of each character type constituting an original document described in the character type format. The language definition table 18 is composed of items “language” 181, “language symbol” 182, “constituent character type symbol” 183.

Language names such as “English” “Japanese” and so on are stored in the “language” 181. A language symbol corresponding to a language name is stored in the “language symbol” 182. In the “constituent character type symbol” 183, the character type symbol “E” representing English and the character type symbols “C” “H” “K” “D” representing Japanese are stored as the constituent character type symbols, in the records corresponding to the language names.

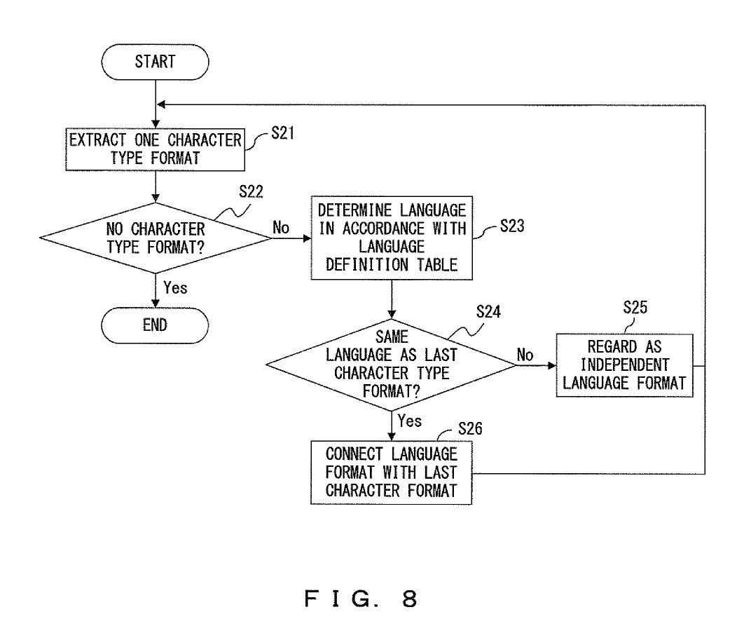

FIG. 8 illustrates the flow for the language analysis unit 13 in the present embodiment. The language analysis unit 13 extracts a character type symbol that has been involved in the conversion in the character type processing unit 12 (S21). When there is a character to extract (S22, “No”), the language analysis unit 13 determines which language the character type symbol corresponds to, in accordance with the language definition table 18 (S23). When the extracted character type symbol is “E”, the language analysis unit 13 determines its language as “English”. When the extracted character type symbol is “C” “H” “K”, or “D”, the language analysis unit 13 determines its language as “Japanese”.

At this time, the language analysis unit 13 determines whether the character type involved in the current determination is the same as the character type involved in the end determination (S24). When the character type involved in the current determination is the same as the character type involved in the end determination, the language analysis unit 13 connects the character type symbol involved in the current determination with the character type format involved in the end determination (S26) For example, when the character type symbol involved in the current determination and the character type involved in the end determination are successively “E”, the successive parts for the character type are regarded as a part corresponding to one language (i.e., English part). When the character type symbol involved in the current determination and the character type involved in the end determination are successively “C” “H” “K”, or “D”, the successive parts for the character type are regarded as a part corresponding to one language (i.e., Japanese part).

When the character type symbol involved in the current conversion does not correspond to the character type involved in the end conversion process, (S24, “No”), the language analysis unit 13 describes the character type symbol involved in the current conversion in a character type format independent from the character type format involved in the end conversion process.

The language analysis unit 13 performs the language analysis process from the beginning and the end of the character type format, character by character, in accordance with the flow in FIG. 8. Then, the original document is described with the symbols specified as Japanese and the symbols specified as English.

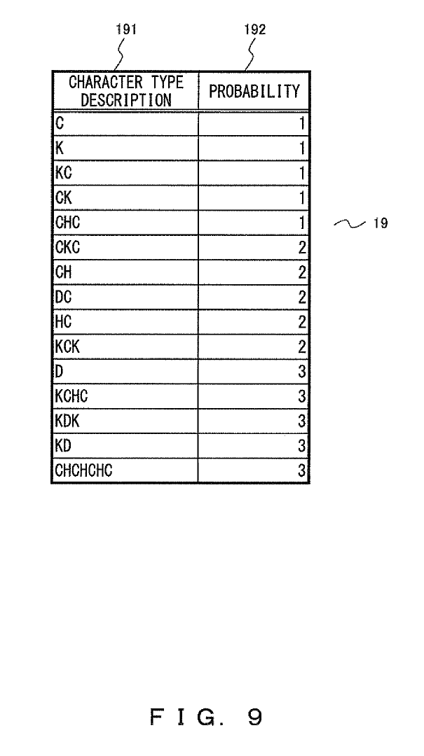

FIG. 9 illustrates an example of the word definition table 19 in the present embodiment. The word definition table 19 is used to identify a word from a character type of a language such as Japanese in which words are not separated by spaces. In other words, the word definition table 19 is used when the word processing unit 14 extracts a word from an original document that contains a mixture of different languages.

The word definition table 19 is composed of items “character type description” 191 and “probability” 192. Combination patterns of the character types “C” “H” “K”, and “D” are stored in the “character type description” 191.

The probability indicating the possibility at which a combination pattern of character types stored in the “character type description” 191 represents a word is stored in the “probability” 192. The probability indicates the degree of the possibility at which a combination pattern of character types (character type description) corresponds to a word. The possibility of being a word decreases, in the order of the probabilities “1” “2” “3”.

For example, the character type pattern “K” indicates a word that contains the katakana character only. The number of character(s) may be either one or more. The character type pattern “CHC” indicates a word composed of the Chinese character and Hiragana character, in which the sequence of one or more characters is “Chinese character-Hiragana-Chinese character”. The pattern “CHC” indicates, for example, words such as [symbol] [symbol] [symbol] [symbol] [symbol] [symbol] [symbol] [symbol] and so on.

The character type description can be defined by a combination of given character type symbols. In addition, the words that are already registered in the translation dictionary may be described in the character type format, and patterns of character type format with frequent appearances may be registered. New registration, edition and deletion can be performed for the word definition table 10.

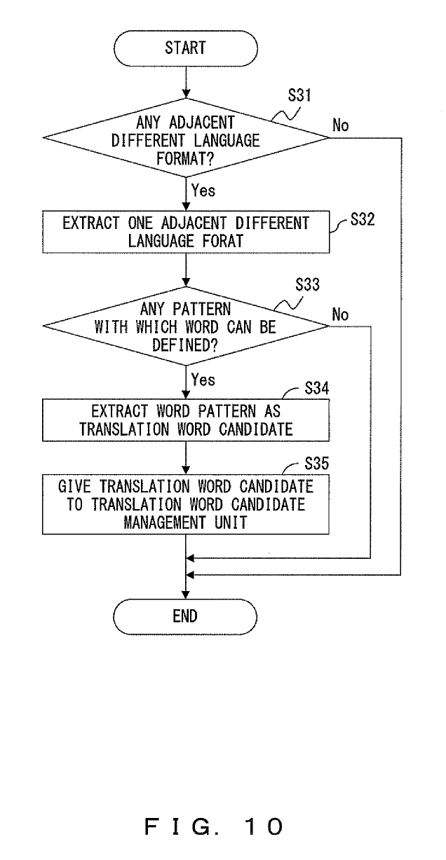

FIG. 10 illustrates the flow for the word processing unit 14 in the present embodiment. First, the word processing unit 14 determines, in an original document described in the character type format and the language format, whether there are parts that are described in different language formats and are adjacent to each other (S31). When there are no parts that are described in different language formats and are adjacent to each other, the flow is terminated.

When there are parts that are described in different language formats and are adjacent to each other, the word processing unit 14 extracts parts replaced with the character type format, corresponding to the adjacent parts described in different language formats (S32). The word processing unit 14 determines, on the basis of the word definition table 19, in the combination pattern of the character type symbols constituting the extracted parts replaced with the character type format, whether a word can be defined by the pattern (S33). When the word processing unit 14 determines that a word cannot be defined by the pattern (“No” in S33), the flow is terminated.

When there is a pattern with which a word can be defined according to the determination on the basis of the word definition table 19 (“Yes” in S33), the word processing unit 14 extracts the word corresponding to the combination pattern of the character type symbols as a translation word candidate (S34). In other words, the word processing unit 14 regards, in the parts described in the character type format, a part corresponding to one in the word definition table 19 as a word. For example, (1) when the character type parts extracted as the adjacent parts described in different language formats are “Japanese” “English”, since the Japanese part precedes the English part, the character types constituting the Japanese part are extracted sequentially, starting from the end character type, as the character types of the part; (2) when the character type parts extracted as the adjacent parts described in different language formats are “English” “Japanese”, since the English part precedes the Japanese part, the character types constituting the Japanese part are extracted sequentially, starting from the first character type, as the character types of the part; (3) meanwhile, the character type for which the word target is defined as “X” in the character type code table 17 is not included in a word.

The word processing unit 14 gives the translation word candidate extracted in S34 to the translation word candidate management unit 15 (S35). At this time, the “probability” 192 corresponding to the combination of the character types (character type description) is also stored in the translation word candidate DB 5. The “probability” is utilized, when a search is performed in the translation word candidate DB 5 and the search result is displayed, as a basis of the order of priority of the display, and so on. When statistics have been taken from the translation dictionary for a character type format, the probability can be determined on the basis of its rate of appearance.

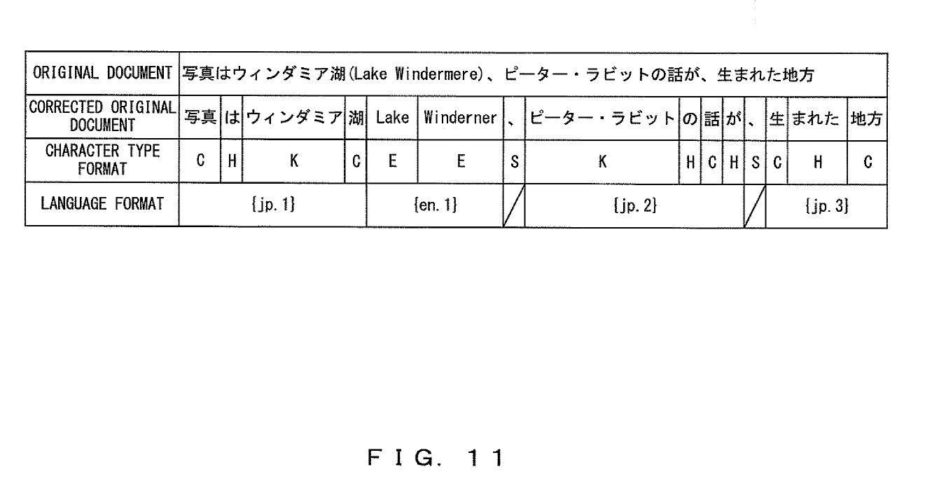

FIG. 11 illustrates an example of the character type analysis using an example sentence performed by the word analysis unit 3 in the present embodiment. Described below is a case in which the collection unit 2 collects a sentence [symbol] [symbol] (Lake Windermere), [symbol] [symbol] [symbol] that contains a mixture of Japanese and English as an original document OD 1, and the original document OD 1 is input to the original document correction processing unit 11.

The original document correction processing unit 11 performs the correction of the original document OD 1 in accordance with the correction code table 16. In this case, the characters “( )” in the original document OD 1 are the target of the correction, and the characters “( )” are deleted from the original document OD 1 in accordance with the replacement code “delete”. As a result, a corrected original document OD 2 [symbol] [symbol] [symbol] Lake Windermere, [symbol] [symbol] [symbol] is generated.

Next, the character type description processing unit 12 generates a character string in which the corrected original document OD 2 is converted into the character type format on the basis of the character type code table 17. The character type description processing unit 12 checks the character type from the beginning of the corrected original document OD2, character by character.

In FIG. 11, the character codes of [symbol] are “¥u5199¥u771f”, so it is replaced into the character type “C”. In the same way, [symbol] is Hiragana so it is replaced with “H”; [symbol] contains the similar Katakana characters so it is replaced with “K”; [symbol] is CJKUnifiedIdeographs so it is replaced with “C”; “Lake” contains similar English characters so it is replaced with “E”; “Windermere” contains similar English characters so it is replaced with “E”; [symbol] is Comma, Full Stop so it is replaced with “S”; [symbol] contains similar Katakana characters so it is replaced with “K”; [symbol] is CJKUnifiedIdeographs so it is replaced with “C”; [symbol] is Hiragana so it is replaced with “H”; [symbol] is Comma, Full Stop so it is replaced with “S”; [symbol] is CJKUnifiedIdeographs so it is replaced with “C”; [symbol] contains similar Hiragana characters so it is replaced with “H”; [symbol] contains similar CJKUnifiedIdeographs so it is replaced with “C”.

In this regard, for the word Lake, the space immediately after “e” is included as the spelling because the word analysis for the “E” word is performed in accordance with “space separations”. Since the space immediately before Windermere indicates a word separation, the spelling from W to e is regarded as “E”.

Thus, the character type processing unit 12 generates, from the corrected original document OD 2, a character string TS described in the character type format “C” “H” “K” “C” “E” “E” “S” “K” “H” “C” “H” “S” “C” “H” “C”.

The language analysis unit 13 describes the character string TS with language symbols (symbols that represent the language formats) on the basis of the language definition table 18, sequentially to identify which language each of the character types constituting the character string TS corresponds to. In other words, “CHKC” from the beginning of the character string TS corresponds to Japanese, so it is described in the language format {jp.1}, in which “jp” represents Japanese, “.” represents a separation mark, and “1” represents the first Japanese group.

The subsequent two “E”s are English, so they are described as {en.1} (first English), in which “en” represents English, “.” represents a separation mark, and “1” represents the first English group.

According to the correction code table 16, “S” is skipped as it is excluded from the word target. The subsequent character type format “KHCH” is Japanese, so it is described in the language format {jp.2} (second Japanese). Then, “S” appearing again is skipped. The subsequent “CHC” is Japanese, so it is described as {jp.3} (second Japanese).

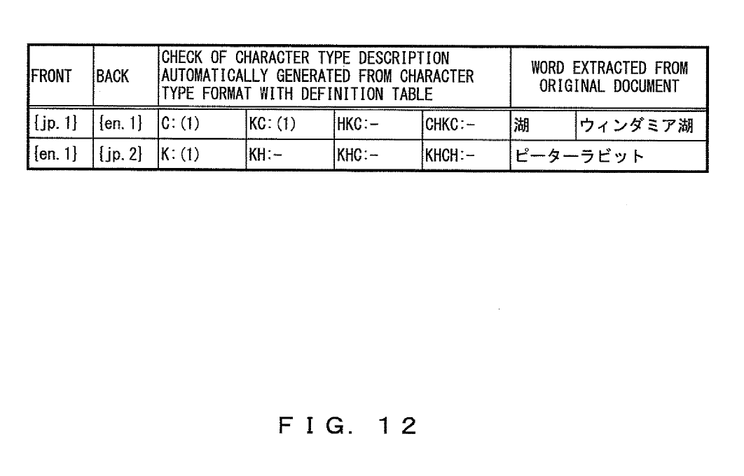

FIG. 12 illustrates an example of character type analysis based on the word definition table 19 performed by the word analysis unit 3 in the first embodiment. The word processing unit 14 determines adjacent language format in the character string TS described in the character format, and extracts a pair of the language format “English” and a preceding language format, and a pair of the language format “English” and a subsequent language format. In FIG. 12, the word processing unit 14 extracts two pairs, i.e., {jp.1}{en.1}, {en.1}{jp.2}.

In the case of {jp.1} {en.1}, the word processing unit 14 performs block analysis for {jp.1} in accordance with the word definition table 19. Since {jp.1} is a character string described in the character type format “CHKC” and precedes {en.1}, the four patterns from the end of the character string, i.e., “C” “KC” “HKC” “CHKC” are checked with the character type patterns in the word definition table 19. Meanwhile, “C: (1)”, “KC (1)” in FIG. 12 represent a word with probability 1.

According to the processing process, C is [symbol] KC is [symbol] [symbol] Therefore, the word processing unit 14 extracts two translation words, namely Japanese [symbol] for English “Lake Windermere” and Japanese [symbol] for English “Lake Windermere”.

The translation word candidate management unit 4 registers Japanese [symbol] English “Lake Windermere” and 1 as the probability information in the translation word candidate DB 5. At this time, when the contents to be registered have not been registered in the translation word candidate DB 5, the translation word candidate management unit 4 adds a new record to the table in the translation word candidate DB 5. When the contents to be registered have already been registered in the translation word candidate DB 5, the translation word candidate management unit 4 adds “+1” to the data item “number of hits” in the existing record.

In the case of {en.1} {jp.2}, the word processing unit 14 performs block analysis for {jp.2} in accordance with the word definition table 19. Since {jp.2} is a character string described in the character type format “KHCH” subsequent to {en.1}, the four patterns from the first character of the character string, i.e., “K” “KH” “KHC” “KHCH” are checked with the character type patterns in the word definition table 19. Meanwhile, “K: (1)” in FIG. 12 represents a word with probability 1.

According to the processing process, K is [symbol] [symbol] and {en.1} is “Lake Windermere”. Therefore, the word processing unit 14 extracts one translation word, namely Japanese [symbol] for English “Lake Windermere”.

The translation word candidate management unit 4 registers Japanese [symbol] English “Lake Windermere” and 1 as the probability information in the translation word candidate DB 5. At this time, when the contents to be registered have not been registered in the translation word candidate DB 5, the translation word candidate management unit 4 adds a new record to the table in the translation word candidate DB 5. When the contents to be registered have already been registered in the translation word candidate DB 5, the translation word candidate management unit 4 adds “+1” to the data item “number of hits” in the existing record.

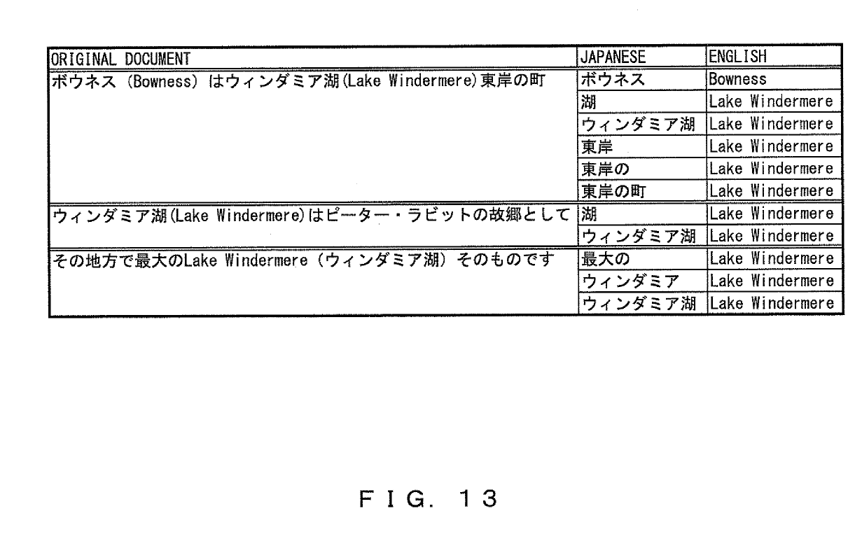

FIG. 13 is a diagram for explaining an example of extracting a word in other example sentences in the present embodiment. Japanese and English words are extracted from each original documents with the similar processes to the ones described above performed by the word analysis unit 3.

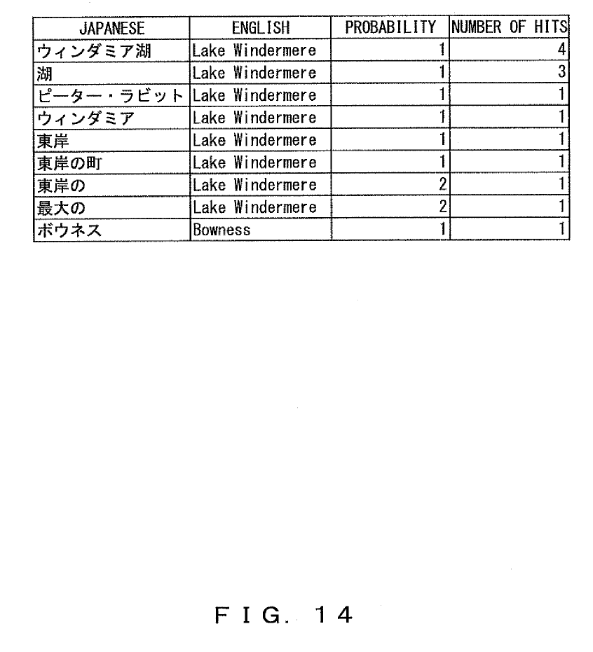

FIG. 14 illustrates an example of a translation word candidate table stored in a translation word candidate DB 5 in the present embodiment. The translation word candidate DB 5 stores the probability information defined in the word definition table 19 and the number of extraction which are added to a word extracted by the word analysis unit 3 as accompanying information.

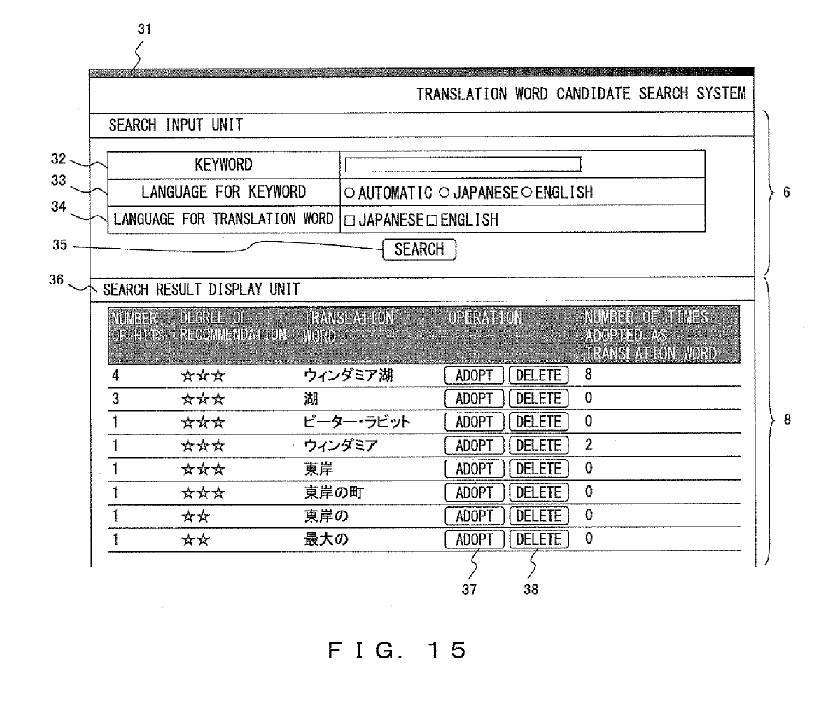

FIG. 15 illustrates an example of the screen of a translation word candidate search system in the present embodiment. A screen 31 illustrated in FIG. 15 is an example of a user interface of a system with which a user of a translation word candidate search service performs a search for a translation word.

The screen 31 is composed of, generally, a search input unit 6 and a search result display unit 8. The search input unit 6 is equipped with a keyword input unit 31 for inputting a word of which translation is sought, a keyword language selection button 33 for selecting the language for the keyword, a translation word language selection button 34 for selecting the language for the translation word, and a search button 25.

The search result display unit 8 displays a search list 36 as the search result. The search list 36 is composed of, for example, items “number of hits”, “degree of recommendation”, “translation word”, “operation”, “number of times of being adopted as translation word”. The “number of hits” and “degree of recommendation” correspond to the “number of hits” and “probability” in the translation word candidate table.

When “Lake Windermere” is input to the keyword input unit 32 and the search button 35 is tapped to perform a search for a keyword, [symbol] is displayed in the search list 36 in the search result display unit 8 as a word that appears at the highest rate as a word adjacent to “Lake Windermere”.

When “Lake Windermere” is input to the keyword input unit 32, and English is specified as the language for the keyword and Japanese is specified as the language for the translation by means of the keyword language selection button 33, a search processing unit 7 performs a search for “Lake Windermere” in the “English” column in the translation word candidate DB 5. Generally, a word that matches fully to the keyword is detected from words included in the “English” column. However, this is not a limitation, and a word matching under the condition of search options such as partial match, no distinction between English upper case and lower case, no distinction between one-bit and two-bit, and so on.

FIG. 14 describes the translation word candidate DB 5 in which the probability and the number of hits are registered as the example of accompanying information. However, in a case in which translation candidates are extracted from Web pages or a file depository shared on a network, a file from which an original document is extracted may be updated. For this reason, the file information of the original document extraction source may be added as accompanying information of a translation word candidate word. In addition, sequentially to avoid the increase of the number of translation word candidate words due to the use of the same original document, it is preferable to adopt, for an updated file, only the updated parts as the original document, using a difference management system.

For a translation work done by a human, not only translation word but also pieces of information such as its usage examples and source are important for selecting a translation word. In such a service, the link to the document being the source of the extraction of a translation word candidate word or to the file being the source of an original document may be added as accompanying information of the translation word candidate word.

The search result check unit 8 of the translation word candidate search service illustrated in FIG. 15, “adopt” button 37 and “delete” button 38 are provided for the displayed translation word candidate words. This enables the feedback by the user as to whether the words have been adopted as a translation word, whether the words should be deleted, and so on.

For example, when a user adopts either of the words as a translation word of a keyword, the user is asked to tap the “adopt” button 37. In this case, the number of times that the word is adopted is added as accompanying information of the translation word candidate word, so that other user can refer to the information.

Meanwhile, for a translation word that the user feels as inappropriate, the user is asked to tap the “delete” button 38. In this case, the word can be deleted from the translation word candidate list displayed for the user, and the number of times that the word has been determined as an inappropriate translation word can be added as accompanying information of the translation word candidate word. In addition, when a plurality of users determine the word as inappropriate, a process such as to delete the word from the translation word candidate DB 5 may be performed.

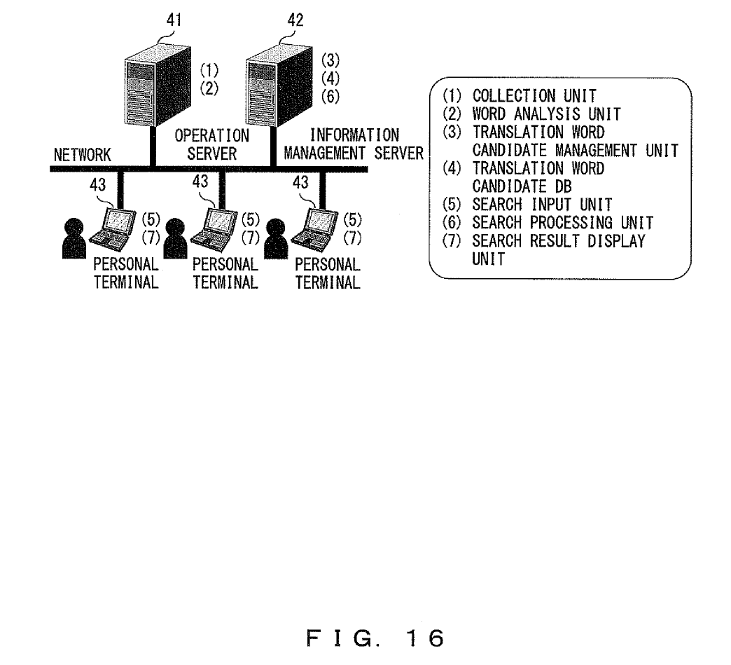

FIG. 16 illustrates a configuration example of a network in the present embodiment. Servers 41, 42 and a personal terminal 43 exist on the network. The servers 41 and 42 are computers having a CPU, RAM, ROM, mass storage apparatus and communication interface. The personal terminal is also a computer having a CPU, RAM, ROM, mass storage apparatus and communication interface.

In the operation server 41, a program functioning as the collection unit 2 and the word analysis unit 3 is operating. Meanwhile, a storage system such as a DB exists in the information management server 42, and a program functioning as the translation word candidate management unit 4, the translation word candidate DB 5 and the search processing unit 7 is operating in the server.

The user inputs, from the search input unit 6 in the personal terminal 43, a word of which translation word candidate is to be extracted. Then, a processing request is transmitted to the search processing unit 7 in the information management server 42, via the network. The result of the search is returned to the search result check unit 8 and can be checked on the personal terminal 43 of the user.

The operation server 41 and the information management server 42 described above may be the same server. In addition, if the resource allows, all may be operating on the personal terminal 43. In this case, the connection to the network is not necessary.

While two servers exist in the hardware configuration example described above, more servers may exist. The same role can be played by a plurality of servers using technology such as clustering; or roles can be further divided and the role of the collection unit and that of the word analysis unit may be performed by different servers; or the process of the word analysis unit 3 explained with regard to FIG. 2 may be performed by another server.

### Second Embodiment

Described with this embodiment is an automatic translation that can handle an unknown word, in cooperation with a search system. In other words, described is an example in which, when translating a sentence containing a word that has not been registered in the translation word by an automatic translation system, a translation word is selected automatically by performing word analysis for a search result of an Internet search or a search in an office LAN. In the example described below, while both the search system and the automatic translation system are operating in a portal site on the Web or an office LAN of a company and there is an environment in which the search system and the automatic translation system provide services independently from each other, the translation word candidate search system is adopted by linking the services.

When a sentence containing a word that has not been registered in the translation word is input to the automatic translation system, the unregistered word is input as a keyword to a search input unit of the translation word candidate search system. Explained below is an example in which, when performing English-to-Japanese translation by the translation system, “Lake Windermere” is determined as an unregistered word by the translation system and is input to the translation word candidate search system.

The translation word candidate search system performs the extraction of a translation word candidate for a search index collected by the search system. The same elements as in the first embodiment are described with the same numerals, and the explanation for them is omitted.

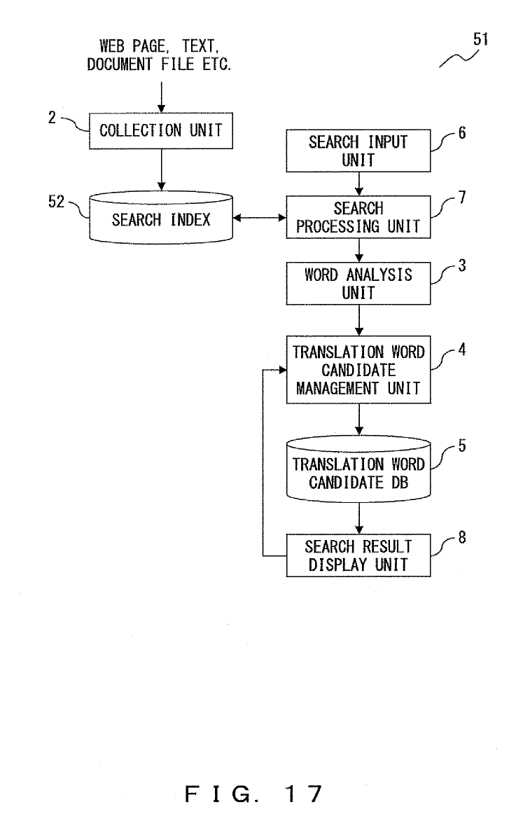

FIG. 17 illustrates an outline of a system 51 that performs word analysis for the search result of a search system in the present embodiment. The collection unit 2 is a program such as, what is called, a Web crawler, collecting files such as accessible Web pages and the like.

A search index 52 stores files collected by the collection unit 2. A database or index format for which a high-speed search can be performed is adopted in the search index 52.

The search input 6 has, as illustrated in FIG. 15, at least, input items such as the keyword input unit 32, the search button 35 for starting the search process in the search index 52 and word analysis, the keyword language selection button 33 with which the language (such as Japanese, English) for the keyword can be selected, the translation word language selection button 34 with which the language for the translation word can be selected, and so on. If the system involves only two languages such as Japanese/English, an automatic determination can be performed, in which the language of the keyword is determined by a process similar to that performed by the word analysis unit 3, and the other language is determined as the language for the translation word. In this case, the language selection buttons 33 and 34 for specifying the languages for the keyword and for its translation word are not required.

The search processing unit 7 is a program such as, so called, a full-text search engine, with which a search for a file of an Web page and so on including the keyword is performed in the search index 52. In addition, the search processing unit 7 has an interface with which data such as a document including the keyword can be provided to the word analysis unit 3.

The word analysis unit 3 generates the translation word candidate DB 5 on the basis of the keyword, the language for the keyword, text data including the keyword and the language for the translation word.

The search result display unit 8 displays a list 34 of the searched words. The search result display unit 8 may have an operation button that can specify the display order, such as a descending or ascending order with regards to the number of hits, a descending or ascending order with regard to the probability, and so on.

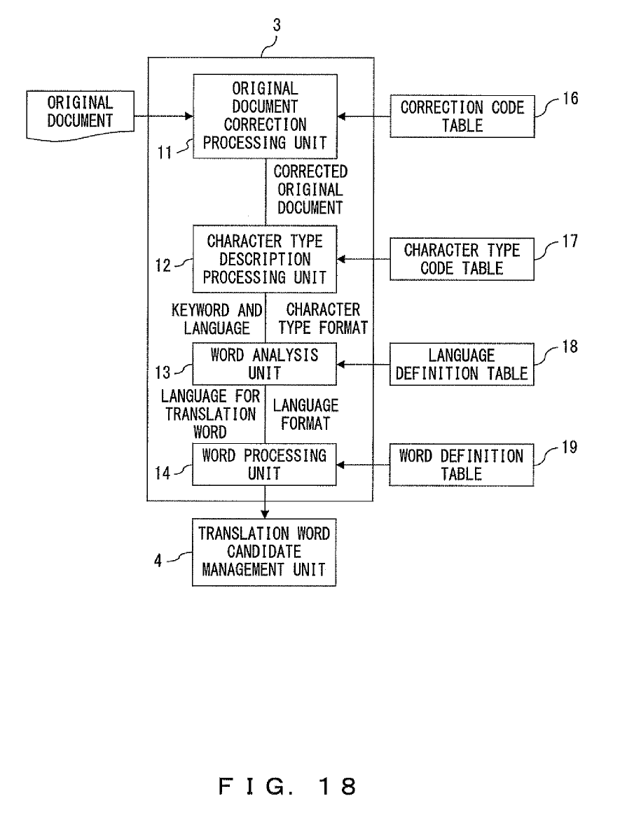

FIG. 18 illustrates the configuration of the word analysis unit 3 in the present embodiment. The word analysis unit 3 extracts a word that has a possibility of being a translation word from an original document, and stores it in a storage system such as the translation word candidate DB 5.

The original document correction processing unit 11 generates, in the same manner as in the first embodiment, a corrected original document OD 2 from which elements that are not required as the constituent elements of an original document OD 1, such as parentheses, have been eliminated.

The character type description processing unit 12 generates, from the original document OD 2, in the same manner as in the first embodiment, a character type format in which characters are replaced with character type symbols such as “English alphabet” “Chinese character” “hiragana” “katakana”, and so on, in accordance with the character type code table 17.

The language analysis unit 13 generates a language format in which the Japanese parts and the English parts in the original document are replaced with the respective language type symbols in accordance with the language definition table 18. The difference over the first embodiment is that a search keyword and language are set in the language format.

The word processing unit 14 extracts, from the language formats preceding and subsequent to the search keyword, the one corresponding to the language for the translation word, in the same manner as in the first embodiment. For some languages, a word is extracted in accordance with the word definition unit 19. The extracted word is registered in the translation word candidate DB 5 by the translation word candidate management unit 4, in the same manner as in the first embodiment.

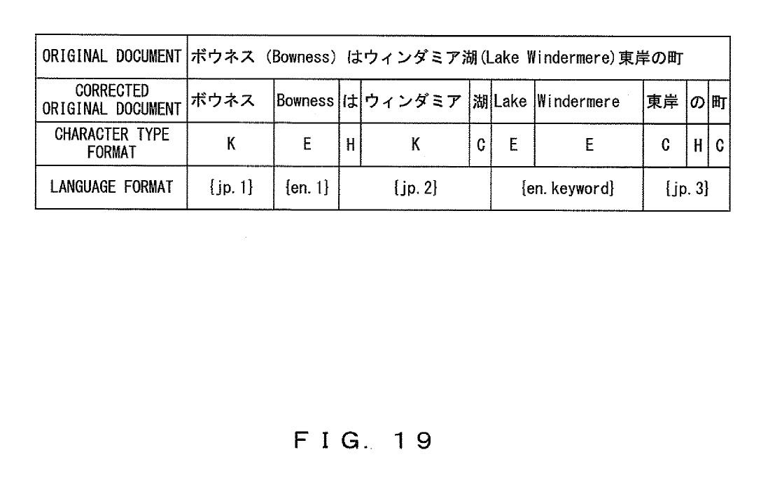

FIG. 19 illustrates an example of character type analysis using an example sentence performed by the word analysis unit 3 in the present embodiment. When a sentence [symbol] (Bowness) [symbol] (Lake Windermere) [symbol] that contains a mixture of Japanese and English is input, the correction of the original document is performed in accordance with the correction code table 16. In this case, the characters “( )” in the original document OD 1 are the target of the correction, so they are deleted in accordance with the replacement code “delete”. The corrected original document is [symbol] Bowness [symbol] Lake Windermere [symbol] .

The character type description processing unit 12 generates a character string in which the corrected original document OD 2 is converted to the character type format. The character type description processing unit 12 checks the character type from the beginning of the corrected original document OD 2, character by character. The character codes of [symbol] are “ [symbol] u30dc [symbol] u30a6 [symbol] u30cc [symbol] u30b9”, they are replaced with “K”.

In the same manner, “Bowness” contains similar English characters so it is replaced with “E”; [symbol] is Hiragana so it is replaced with “H”; [symbol] contains similar Katakana characters so it is replaced with “K”; [symbol] is CJKUnifiedIdeographs so it is replaced with “C”; “Lake” contains similar English characters so it is replaced with “E”; “Windermere” contains similar English characters so it is replaced with “E,”; [symbol] contains the similar CJKUnifiedIdeographs so it is replaced with “C”; [symbol] is Hiragana so it is replaced with “H”; [symbol] is CJKUnifiedIdeographs so it is replaced with “C”. The spelling for Lake includes the space immediately after “e” because the word analysis for the “E” word is performed in accordance with “space separations”. Since the space immediately before Windermere indicates a word separation, the spelling from W to e is regarded as “E”.

Thus, the character type processing unit 12 generates, from the corrected original document OD 2, a character string TS described in the character type formats “K” “E” “H” “K” “C” “E” “E” “C” “H” “C”.

The language analysis unit 13 describes the character string TS with symbols that represent the language formats, sequentially to identify which language each of the character types constituting the character string TS corresponds to. In this case, the first character “K” corresponds to Japanese, so it is described in the language format {jp.1} in which “jp” represents Japanese, “.” represents a separation mark, and “1” represents the first Japanese group.

The next character type format “E” is English, so it is described as {en.1} (first English), in which “en” represents English, “.” represents a separation mark, and “1” represents the first English group.

The subsequent character type format “HKC” is Japanese, so it is described as {jp.2} (second Japanese); “EE” is English corresponding to the keyword so it is determined as {en.keyword}; and “CHC” is Japanese so it is determined as {jp.3} (third Japanese).

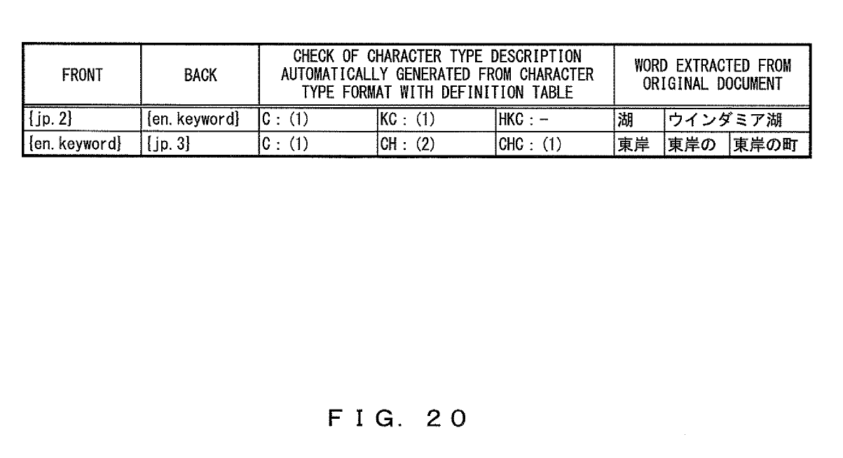

FIG. 20 is an example of character type analysis based on a word definition table 19 performed by the word analysis unit 3 in the present embodiment. The word processing unit 14 extracts two pairs, i.e., {jp.2} {en.keyword}, {en.keyword} {jp.3} before and after the keyword and correspond to the language for the translation word.

In the case of {jp.2} {en.keyword}, the word processing unit 14 performs block analysis for {jp.2} in accordance with the word definition table 19. Since {jp.2} is a character string described in the character type format “HKC” and precedes {en.keyword}, the three pattern from the end of the character string, i.e., “C” “KC” “HKC” are checked with the character type patterns in the word definition table 19. Meanwhile, “C: (1)” “KC: (1)” in FIG. 20 represent a word with probability 1.

According to the processing process, C is [symbol] KC is [symbol] [symbol] Therefore, the word processing unit 14 extracts two translation words, namely Japanese [symbol] for English “Lake Windermere” and Japanese [symbol] for English “Lake Windermere”.

The translation word candidate management unit 4 registers Japanese [symbol] English “Lake Windermere” and Japanese [symbol] [symbol] English “Lake Windermere” in the translation word candidate DB 5. At this time, when the contents to be registered have not been registered in the translation word candidate DB 5, the translation word candidate management unit 4 adds a new record to the table in the translation word candidate DB 5. When the contents to be registered have already been registered in the translation word candidate DB 5, the translation word candidate management unit 4 increments the data item “number of hits” in the existing record.

In the case of {en.keyword} {jp.3}, the word processing unit 14 performs block analysis for {jp.3} in accordance with the word definition table 19. Since {jp.3} is a character string described in the character type format “CHC” subsequent to {en.1}, the three pattern from the beginning of the character string, i.e., “C” “CH” “CHC” are checked with the character type patterns in the word definition table 19. Meanwhile, “CHC: (1)” in FIG. 20 represents a word with probability 1, and “CH: (2)” represents a word with probability 2.

According to the processing process, C is [symbol] CH is [symbol] and CHC is [symbol] Therefore, the word processing unit 14 extracts three words, namely Japanese [symbol] for English “Lake Windermere”, [symbol] for English “Lake Windermere”, and [symbol] for English “Lake Windermere”.

The translation word candidate management unit 4 registers Japanese [symbol] English “Lake Windermere”, [symbol] English “Lake Windermere”, and [symbol] “Lake Windermere” in the translation word candidate DB 5. At this time, when the contents to be registered have not been registered in the translation word candidate DB 5, the translation word candidate management unit 4 adds a new record to the table in the translation word candidate DB 5. When the contents to be registered have already been registered in the translation word candidate DB 5, the translation word candidate management unit 4 adds “+1” the data item “number of hits” in the existing record.

The translation candidate search system gives a list of the translation word candidates and their accompanying information to the automatic translation system. The automatic translation system selects a translation word that it determines as optimal, on the basis of information such as the number of hits and the probability illustrated in FIG. 14, and reflects it in the result of the automatic translation. In the case in which the translation word candidate search system gives the search result from FIG. 14 to the automatic translation system and the automatic translation system adopts the number of hits as the information for determining the optimal translation word, [symbol] is selected as the Japanese translation word for “Lake Windermere”.

In this example, the search result display unit 8 of the translation word candidate search system displays the result of the automatic translation output from the automatic translation system.

When the user of the automatic translation system revises the translation word extracted by the translation word candidate search system with a different word or registers another translation word for the same unregistered word in the translation dictionary, the automatic translation system performs a feedback to the translation word candidate search system, so that the number of times that a translation word candidate word has been rejected can be added as accompanying information of the translation word candidate word, or the translation word candidate word can be deleted from the translation word candidate DB.

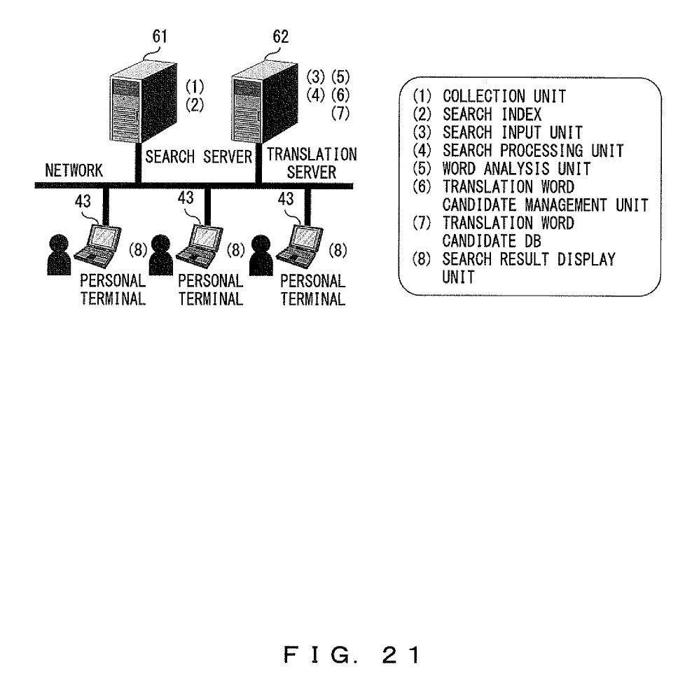

FIG. 21 illustrates a configuration example of a network in the present embodiment. Servers 61, 62 and a personal terminal 43 exist on the network. A program functioning as the collection unit 2 and the search index 52 exists in the search server 61. In addition, other than the translation system, a program functioning as the search processing unit 7, the word analysis unit 3, the translation word candidate management unit 4 and the translation word candidate DB 5 exists in the translation server 62.

A user sends, from the personal terminal 43 to the translation server 62 via the network, a translation request of a sentence containing a word that has not been registered in the dictionary of the translation system. The translation system in the translation server 62 obtains, in the course of the translation process, a sentence containing a keyword from the search server 61, the keyword being the translation word of the word that has not been registered in the dictionary.

The translation word candidate management unit 4 operates for the sentence being the target, and stores translation word candidates in the translation word candidate DB 5. The translation system reflects the translation word that it determines as optimal among the translation word candidates in the result of the translation, and returns the result of the translation to the personal terminal of the user.

Meanwhile, the search server 61 and the translation server 62 described above may be the same server. In addition, if the resource allows, all may be operating on the personal terminal. In this case, the connection to the network is not necessary.

While two servers exist in the hardware configuration example described above, more servers may exist. The same role can be played by a plurality of servers using technology such as clustering; or roles can be further divided and the role collection unit 2 and that of the word analysis unit 3 may be performed by different servers; or the process of the word analysis unit 3 explained with regard to FIG. 2 may be performed by another server.

In a case such as one in which a request for a translation word candidate search is sent from the translation system and the same word has been searched in the past, the speeding-up of the process can be performed by using a cache and the like. In a case such as one in which the translation word candidate DB already has translation word candidates, the process may be performed for the translation word candidates that have already been registered, sequentially to give priority to the response speed.

When any translation word candidate could not be found, the translation system treats the word as a word that has not been registered in the dictionary. When the translation system determines a word as inappropriate, such as when the number of hits is too small or the word has already been registered as a translation word of another word, the word may be treated as an unregistered word.

While an English word is input in a generated translation word candidate DB as a keyword and its translation word in Japanese is displayed in the embodiments described above, a Japanese word may be input in a generated translation word candidate DB as a keyword, and its translation word in English may be displayed. In addition, while English-Japanese translation is explained in the above embodiments, any language in which words are separated by spaces, i.e., not only English but also Latin, French, German, Spanish, etc. may be the counterpart of Japanese.

According to the first and second embodiments, a translation word candidate list can be obtained with a single keyword search, and, the number of appearance of each candidate on the Internet can be obtained at the same time, with which the reduction of the time required for the operation of searching for the translation word and the improvement of the operation quality can be expected.

Meanwhile, the first and embodiments are not limited to the embodiments described above, and various configurations or embodiments may be adopted without departing from the scope of the first and second embodiments.

In a portable storage medium according to the first embodiment storing a translation support program that makes a computer execute processes supporting translation of an original document being document data containing Japanese and a foreign language for expressing a word of one language in another language, the program includes an original document correction process correcting, on the basis of a correction related information storing a correction target character and correction detail information for the correction target character, the correction target character contained in the original document in accordance with the correction detail information, and generating a corrected original document; a character type symbol string generation process replacing each character constituting the corrected original document with a character type symbol that is a symbol specifying a type of a character, and generating a character type symbol string in which one symbol is used for describing adjacent same character type symbols; a language symbol string generation process replacing each character type symbol constituting the character type symbol string with a language symbol that is a symbol specifying a language, and generating a language symbol string in which one symbol is used for describing adjacent same language symbols; a word pair obtaining process extracting, from adjacent language symbols in the language symbol string, language symbols that are different from each other, and obtaining, from the extracted pair, a word pair of a Japanese word corresponding to a combination pattern of the character type symbols related to a language symbol representing Japanese and a word in the foreign language corresponding to the Japanese word; and a translation word candidate registration process registering, with respect to one word in the obtained word pair, another word in the obtained word pair as a translation word candidate of the one word in the obtained pair.

The configuration as described above makes it possible to obtain a translation word candidate list with a single keyword search, on the basis of a translation word candidate DB generated on the basis of collected original documents in advance.

In the portable storage medium, in the language symbol string generation process, when a type of a character represented by the character type symbol is a character type symbol that has been registered in advance as a type that is not a constituent element of a word, a replacement of the character type symbol with the language symbol can be performed, while excluding the character type symbol that has been registered in advance as a type that is not a constituent element of a word.

The configuration as described above makes it possible to exclude character type symbols that do not constitute a word in advance.

In the portable storage medium, in the word pair obtaining process, when language symbols different from each other in adjacent language symbols in the language symbol string are extracted as a pair and a Japanese part in the pair is located in front and a foreign language part is located at rear, character type symbols are cumulatively extracted sequentially from an end of the character types related to the Japanese part; when language symbols different from each other in adjacent language symbols in the language symbol string are extracted as a pair and a foreign language part in the pair is located in front and a Japanese part is located at rear, character type symbols are cumulatively extracted sequentially from a beginning of the character types related to the Japanese part; and patterns of the extracted character types are narrowed down on the basis of a probability in word definition information storing a combination pattern of the character type symbols and the probability that indicates a degree of a possibility at which the combination pattern constitutes a word, and a Japanese word in the original document corresponding to the narrowed down character type pattern and a word in the foreign language in the original document corresponding to a character type of the foreign language part can be obtained as a pair.

The configuration as described above makes it possible to obtain a translation word corresponding to character type symbols that should be extracted as the translation word, in accordance with the probability.

In the portable storage medium according to the second embodiment storing a translation support program that makes a computer execute processes supporting translation of an original document being document data containing Japanese and a foreign language for expressing a word of one language in another language, the program includes a translation target obtaining process obtaining a word as a translation target; an original document obtaining process obtaining the original document containing the translation target; an original document correction process correcting, on the basis of a correction related information storing a correction target character and correction detail information for the correction target character, the correction target character contained in the original document in accordance with the correction detail information, and generating a corrected original document; a character type symbol string generation process replacing each character constituting the corrected original document with a character type symbol that is a symbol specifying a type of a character, and generating a character type symbol string in which one symbol is used for describing adjacent same character type symbols; a language symbol string generation process in which a character type corresponding to the translation target in respective character type symbols constituting the character type string is replaced with a translation target symbol indicating a translation target, and a character type symbol other than the translation target is replaced with a language symbol specifying a language, to generate a language symbol string in which one symbol is used for describing adjacent same character type symbols; a word pair obtaining process in which in language symbols located in a front direction of the translation target symbol in the language symbol string, a language symbol that is different from the translation target symbol and is located in a closest position is extracted for a pair, and in language symbols located in a back direction of the translation target symbol in the language symbol string, a language symbol that is different from the translation target symbol and is located in a closest position is extracted for a pair, and a word pair of a Japanese word corresponding to a combination pattern of the character type symbols with respect to a language symbol indicating Japanese in the extracted pair and the translation target corresponding to the Japanese word is obtained; a translation word candidate registration process registering, with respect to one word in the obtained word pair, another word in the obtained word pair as a translation word candidate of the one word in the obtained pair; and a search result display process displaying the registered translation word candidate.

The configuration as described above makes it possible to collect original document and to generate a list of translation word candidates on the basis of the collected original documents, so that a list of translation word candidates can be obtained with a single keyword search.

In the portable storage medium, in the language symbol string generation process, when a type of a character represented by the character type symbol is a character type symbol that has been registered in advance as a type that is not a constituent element of a word, a replacement of the character type symbol with the language symbol can be performed, while excluding the character type symbol that has been registered in advance as a type that is not a constituent element of a word.

The configuration as described above makes it possible to exclude character type symbols that do not constitute a word in advance.

In the portable storage medium, in the word pair obtaining process, when, in language symbols located in a front direction of the translation target symbol in the language symbol string, a language symbol that is different from the translation target symbol and is located closest is extracted for a pair, character type symbols are cumulatively extracted sequentially from an end of the character type related to the Japanese part; when, in language symbols located in a back direction of the translation target symbol in the language symbol string, a language symbol that is different from the translation target symbol and is located closest is extracted for a pair, character type symbols are cumulatively extracted sequentially from a beginning of the character type related to the Japanese part; and patterns of the extracted character type are narrowed down on the basis of a probability in word definition information storing a combination pattern of the character type symbols and a probability that indicates a degree of a possibility at which the combination pattern constitutes a word, and a Japanese word in the original document corresponding to the narrowed down character type pattern and the translation target can be obtained as a pair.

The configuration as described above makes it possible to obtain a translation word corresponding to character type symbols that should be extracted as the translation word, in accordance with the probability.

A translation support system according to the first embodiment supporting translation of an original document being document data containing Japanese and a foreign language for expressing a word of one language in another language includes original document correction means correcting, on the basis of a correction related information storing a correction target character and correction detail information for the correction target character, the correction target character contained in the original document in accordance with the correction detail information, and generating a corrected original document; character type symbol string generation means replacing each character constituting the corrected original document with a character type symbol that is a symbol specifying a type of a character, and generating a character type symbol string in which one symbol is used for describing adjacent same character type symbols; language symbol string generation means replacing each character type symbol constituting the character type symbol string with a language symbol that is a symbol specifying a language, and generating a language symbol string in which one symbol is used for describing adjacent same language symbols; word pair obtaining means extracting, from adjacent language symbols in the language symbol string, language symbols that are different from each other, and obtaining, from the extracted pair, a word pair of a Japanese word corresponding to a combination pattern of the character type symbols related to a language symbol representing Japanese and a word in the foreign language corresponding to the Japanese word; and translation word candidate registration means registering, with respect to one word in the obtained word pair, another word in the obtained word pair as a translation word candidate of the one word in the obtained pair.

The configuration as described above makes it possible to obtain a translation word candidate list with a single keyword search, on the basis of a translation word candidate DB generated on the basis of collected original documents in advance.

A translation support system according to the first embodiment supporting translation of an original document being document data containing Japanese and a foreign language for expressing a word of one language in another language includes translation target obtaining means obtaining a word as a translation target; an original document obtaining process obtaining the original document containing the translation target; original document correction means correcting, on the basis of a correction related information storing a correction target character and correction detail information for the correction target character, the correction target character contained in the original document in accordance with the correction detail information, and generating a corrected original document; character type symbol string generation means replacing each character constituting the corrected original document with a character type symbol that is a symbol specifying a type of a character, and generating a character type symbol string in which one symbol is used for describing adjacent same character type symbols; language symbol string generation means by which a character type corresponding to the translation target in respective character type symbols constituting the character type string is replaced with a translation target symbol indicating a translation target, and a character type symbol other than the translation target is replaced with a language symbol specifying a language, to generate a language symbol string in which one symbol is used for describing adjacent same character type symbols; word pair obtaining means by which in language symbols located in a front direction of the translation target symbol in the language symbol string, a language symbol that is different from the translation target symbol and is located in a closest position is extracted for a pair, and in language symbols located in a back direction of the translation target symbol in the language symbol string, a language symbol that is different from the translation target symbol and is located in a closest position is extracted for a pair, and a word pair of a Japanese word corresponding to a combination pattern of the character type symbols with respect to a language symbol indicating Japanese in the extracted pair and the translation target corresponding to the Japanese word is obtained; translation word candidate registration means registering, with respect to one word in the obtained word pair, another word in the obtained word pair as a translation word candidate of the one word in the obtained pair; and search result display means displaying the registered translation word candidate.

The configuration as described above makes it possible to collect original document and to generate a list of translation word candidates on the basis of the collected original documents, so that a list of translation word candidates can be obtained with a single keyword search.

Therefore, since a translation word candidate list can be obtained with a single keyword search, the reduction of the time required for the operation of searching for the translation word and the improvement of the operation quality can be expected.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A portable storage medium storing a translation support program that makes a computer execute processes supporting translation of an original document being document data containing Japanese and a foreign language for expressing a word of one language in another language, the program comprising:
an original document correction process correcting, on the basis of a correction related information storing a correction target character and correction detail information for the correction target character, the correction target character contained in the original document in accordance with the correction detail information, and generating a corrected original document;
a character type symbol string generation process replacing each character constituting the corrected original document with a character type symbol that is a symbol specifying a type of a character, and generating a character type symbol string in which one symbol is used for describing adjacent same character type symbols;
a language symbol string generation process replacing each character type symbol constituting the character type symbol string with a language symbol that is a symbol specifying a language, and generating a language symbol string in which one symbol is used for describing adjacent same language symbols;
a word pair obtaining process extracting, from adjacent language symbols in the language symbol string, language symbols that are different from each other, and obtaining, from the extracted pair, a word pair of a Japanese word corresponding to a combination pattern of the character type symbols related to a language symbol representing Japanese and a word in the foreign language corresponding to the Japanese word; and
a translation word candidate registration process registering, with respect to one word in the obtained word pair, another word in the obtained word pair as a translation word candidate of the one word in the obtained pair.

2. The portable storage medium according to claim 1, wherein
in the original document correction process, the correction target character in the original document is deleted, or replaced with a two-bit or one-bit character, on the basis of the correction related information.

3. The portable storage medium according to claim 1, wherein
in the character type symbol string generation process, the character type symbol string is generated from the corrected original document on the basis of character type related information storing the character type symbol, character information included in a type described by the character type symbol, information indicating whether the type is a constituent element of a word, and an analysis method of recognizing a word for a character belonging to the type.

4. The portable storage medium according to claim 1, wherein
in the language symbol string generation process, when a type of a character represented by the character type symbol is a character type symbol that has been registered in advance as a type that is not a constituent element of a word, a replacement of the character type symbol with the language symbol is performed, while excluding the character type symbol that has been registered in advance as a type that is not a constituent element of a word.

5. The portable storage medium according to claim 1, wherein
in the word pair obtaining process,
when language symbols different from each other in adjacent language symbols in the language symbol string are extracted as a pair and a Japanese part in the pair is located in front and a foreign language part is located at rear, character type symbols are cumulatively extracted sequentially from an end of the character types related to the Japanese part;
when language symbols different from each other in adjacent language symbols in the language symbol string are extracted as a pair and a foreign language part in the pair is located in front and a Japanese part is located at rear, character type symbols are cumulatively extracted sequentially from a beginning of the character types related to the Japanese part; and
patterns of the extracted character types are narrowed down on the basis of a probability in word definition information storing a combination pattern of the character type symbols and the probability that indicates a degree of a possibility at which the combination pattern constitutes a word, and a Japanese word in the original document corresponding to the narrowed down character type pattern and a word in the foreign language in the original document corresponding to a character type of the foreign language part are obtained as a pair.

6. The portable storage medium according to claim 5, wherein in the translation word candidate registration process, with regard to one word in the obtained word pair, another word in the obtained word pair is registered as a translation word candidate of the one word, and at the same time, the probability of the character type corresponding to the word and a number of registration of the word pair is registered.

7. The portable storage medium according to claim 1, wherein
the program further comprises:
a translation target obtaining process obtaining a word as a translation target;
a search process searching the translation target from the registered word pair and obtaining the translation word candidate to form a pair with the searched word; and
a search result display process displaying the obtained translation word candidate.

8. The portable storage medium according to claim 1, wherein
the program further comprises:
a translation target obtaining process obtaining a word as a translation target;
an original document obtaining process obtaining the original document containing the translation target; and
a search result display process displaying the registered translation word candidate; and
in the language symbol string generation process, a character type corresponding to the translation target in respective character type symbols constituting the character type string is replaced with a translation target symbol indicating a translation target, and a character type symbol other than the translation target is replaced with a language symbol specifying a language, to generate a language symbol string in which one symbol is used for describing adjacent same character type symbols; and
in the word pair obtaining process, in language symbols located in a front direction of the translation target symbol in the language symbol string, a language symbol that is different from the translation target symbol and is located in a closest position is extracted for a pair, and in language symbols located in a back direction of the translation target symbol in the language symbol string, a language symbol that is different from the translation target symbol and is located in a closest position is extracted for a pair, and a word pair of a Japanese word corresponding to a combination pattern of the character type symbols with respect to a language symbol indicating Japanese in the extracted pair and the translation target corresponding to the Japanese word is obtained.

9. The portable storage medium according to claim 8, wherein
in the word pair obtaining process,
when, in language symbols located in a front direction of the translation target symbol in the language symbol string, a language symbol that is different from the translation target symbol and is located closest is extracted for a pair, character type symbols are cumulatively extracted sequentially from an end of the character type related to the Japanese part;
when, in language symbols located in a back direction of the translation target symbol in the language symbol string, a language symbol that is different from the translation target symbol and is located closest is extracted for a pair, character type symbols are cumulatively extracted sequentially from a beginning of the character type related to the Japanese part; and
patterns of the extracted character type are narrowed down on the basis of a probability in word definition information storing a combination pattern of the character type symbols and a probability that indicates a degree of a possibility at which the combination pattern constitutes a word, and a Japanese word in the original document corresponding to the narrowed down character type pattern and the translation target is obtained as a pair.

10. A translation support system supporting translation of an original document being document data containing Japanese and a foreign language for expressing a word of one language in another language, comprising:
an original document correction unit correcting, on the basis of a correction related information storing a correction target character and correction detail information for the correction target character, the correction target character contained in the original document in accordance with the correction detail information, and generating a corrected original document;
a character type symbol string generation unit replacing each character constituting the corrected original document with a character type symbol that is a symbol specifying a type of a character, and generating a character type symbol string in which one symbol is used for describing adjacent same character type symbols;
a language symbol string generation unit replacing each character type symbol constituting the character type symbol string with a language symbol that is a symbol specifying a language, and generating a language symbol string in which one symbol is used for describing adjacent same language symbols;
a word pair obtaining unit extracting, from adjacent language symbols in the language symbol string, language symbols that are different from each other, and obtaining, from the extracted pair, a word pair of a Japanese word corresponding to a combination pattern of the character type symbols related to a language symbol representing Japanese and a word in the foreign language corresponding to the Japanese word; and
a translation word candidate registration unit registering, with respect to one word in the obtained word pair, another word in the obtained word pair as a translation word candidate of the one word in the obtained pair.

11. The translation support system according to claim 10, wherein
the language symbol string generation unit performs, when a type of a character represented by the character type symbol is a character type symbol that has been registered in advance as a type that is not a constituent element of a word, a replacement of the character type symbol with the language symbol while excluding the character type symbol that has been registered in advance as a type that is not a constituent element of a word.

12 The translation support system according to claim 10, wherein
when language symbols different from each other in adjacent language symbols in the language symbol string are extracted as a pair and a Japanese part in the pair is located in front and a foreign language part is located at rear, the word pair obtaining unit cumulatively extracts character type symbols sequentially from an end of the character types related to the Japanese part;
when language symbols different from each other in adjacent language symbols in the language symbol string are extracted as a pair and a foreign language part in the pair is located in front and a Japanese part is located at rear, the word pair obtaining unit cumulatively extracts character type symbols sequentially from a beginning of the character types related to the Japanese part; and
the word pair obtaining unit narrows down patterns of the extracted character types on the basis of a probability in word definition information storing a combination pattern of the character type symbols and the probability that indicates a degree of a possibility at which the combination pattern constitutes a word, and obtains a Japanese word in the original document corresponding to the narrowed down character type pattern and a word in the foreign language in the original document corresponding to a character type of the foreign language part as a pair.

13. The translation support system according to claim 10, further comprising:
a translation target obtaining unit obtaining a word as a translation target;
a search unit searching the translation target from the registered word pair and obtaining the translation word candidate to form a pair with the searched word; and
a search result display unit displaying the obtained translation word candidate.

14. The translation support system according to claim 10, further comprising:
a translation target obtaining unit obtaining a word as a translation target;
an original document obtaining unit obtaining the original document containing the translation target; and
a search result display unit displaying the registered translation word candidate; and
the language symbol string generation unit replaces a character type corresponding to the translation target in respective character type symbols constituting the character type string with a translation target symbol indicating a translation target, and replaces a character type symbol other than the translation target with a language symbol specifying a language, to generate a language symbol string in which one symbol is used for describing adjacent same character type symbols; and
the word pair obtaining unit extracts for a pair, in language symbols located in a front direction of the translation target symbol in the language symbol string, a language symbol that is different from the translation target symbol and is located in a closest position, and extracts for a pair, in language symbols located in a back direction of the translation target symbol in the language symbol string, a language symbol that is different from the translation target symbol and is located in a closest position, and obtains a word pair of a Japanese word corresponding to a combination pattern of the character type symbols with respect to a language symbol indicating Japanese in the extracted pair and the translation target corresponding to the Japanese word.

15. The translation support system according to claim 14, wherein
when the word pair obtaining unit extracts for a pair, in language symbols located in a front direction of the translation target symbol in the language symbol string, a language symbol that is different from the translation target symbol and is located closest, the word pair obtaining unit extracts character type symbols cumulatively and sequentially from an end of the character type related to the Japanese part;
when the word pair obtaining unit extracts for a pair, in language symbols located in a back direction of the translation target symbol in the language symbol string, a language symbol that is different from the translation target symbol and is located closest, the word pair obtaining unit extracts character type symbols cumulatively and sequentially from a beginning of the character type related to the Japanese part; and
the word pair obtaining unit narrows down patterns of the extracted character type on the basis of a probability in word definition information storing a combination pattern of the character type symbols and a probability that indicates a degree of a possibility at which the combination pattern constitutes a word, and obtains a Japanese word in the original document corresponding to the narrowed down character type pattern and the translation target as a pair.

16. A translation support method supporting translation of an original document being document data containing Japanese and a foreign language for expressing a word of one language in another language, comprising:
correcting, on the basis of a correction related information storing a correction target character and correction detail information for the correction target character, the correction target character contained in the original document in accordance with the correction detail information, and generating a corrected original document;
replacing each character constituting the corrected original document with a character type symbol that is a symbol specifying a type of a character, and generating a character type symbol string in which one symbol is used for describing adjacent same character type symbols;
replacing each character type symbol constituting the character type symbol string with a language symbol that is a symbol specifying a language, and generating a language symbol string in which one symbol is used for describing adjacent same language symbols;
extracting, from adjacent language symbols in the language symbol string, language symbols that are different from each other, and obtaining, from the extracted pair, a word pair of a Japanese word corresponding to a combination pattern of the character type symbols related to a language symbol representing Japanese and a word in the foreign language corresponding to the Japanese word; and
registering, with respect to one word in the obtained word pair, another word in the obtained word pair as a translation word candidate of the one word in the obtained pair.

17. The translation support method according to claim 16, wherein
in generating the language symbol string, when a type of a character represented by the character type symbol is a character type symbol that has been registered in advance as a type that is not a constituent element of a word, a replacement of the character type symbol with the language symbol is performed, while excluding the character type symbol that has been registered in advance as a type that is not a constituent element of a word.

18. The translation support method according to claim 16, wherein
in obtaining the word pair,
when language symbols different from each other in adjacent language symbols in the language symbol string are extracted as a pair and a Japanese part in the pair is located in front and a foreign language part is located at rear, character type symbols are cumulatively extracted sequentially from an end of the character types related to the Japanese part;
when language symbols different from each other in adjacent language symbols in the language symbol string are extracted as a pair and a foreign language part in the pair is located in front and a Japanese part is located at rear, character type symbols are cumulatively extracted sequentially from a beginning of the character types related to the Japanese part; and
patterns of the extracted character types are narrowed down on the basis of a probability in word definition information storing a combination pattern of the character type symbols and the probability that indicates a degree of a possibility at which the combination pattern constitutes a word, and a Japanese word in the original document corresponding to the narrowed down character type pattern and a word in the foreign language in the original document corresponding to a character type of the foreign language part are obtained as a pair.

19. The translation support method according to claim 16, further comprising:
obtaining a word as a translation target;
obtaining the original document containing the translation target; and
displaying the registered translation word candidate; wherein
in generating the language symbol string, a character type corresponding to the translation target in respective character type symbols constituting the character type string is replaced with a translation target symbol indicating a translation target, and a character type symbol other than the translation target is replaced with a language symbol specifying a language, to generate a language symbol string in which one symbol is used for describing adjacent same character type symbols; and
in obtaining the word pair, in language symbols located in a front direction of the translation target symbol in the language symbol string, a language symbol that is different from the translation target symbol and is located in a closest position is extracted for a pair, and in language symbols located in a back direction of the translation target symbol in the language symbol string, a language symbol that is different from the translation target symbol and is located in a closest position is extracted for a pair, and a word pair of a Japanese word corresponding to a combination pattern of the character type symbols with respect to a language symbol indicating Japanese in the extracted pair and the translation target corresponding to the Japanese word is obtained.

20. The translation support method according to claim 19, wherein
in obtaining the word pair,
when, in language symbols located in a front direction of the translation target symbol in the language symbol string, a language symbol that is different from the translation target symbol and is located closest is extracted for a pair, character type symbols are cumulatively extracted sequentially from an end of the character type related to the Japanese part;
when, in language symbols located in a back direction of the translation target symbol in the language symbol string, a language symbol that is different from the translation target symbol and is located closest is extracted for a pair, character type symbols are cumulatively extracted sequentially from a beginning of the character type related to the Japanese part; and
patterns of the extracted character type are narrowed down on the basis of a probability in word definition information storing a combination pattern of the character type symbols and a probability that indicates a degree of a possibility at which the combination pattern constitutes a word, and a Japanese word in the original document corresponding to the narrowed down character type pattern and the translation target is obtained as a pair.
